(19) United States
(12) Patent Application Publication
(10) Pub. No.: US 2024/0098641 A1
(43) Pub. Date: Mar. 21, 2024

(54) TECHNIQUES FOR COMMUNICATING A MULTI-PURPOSE WAKE-UP SIGNAL IN WIRELESS COMMUNICATIONS

(71) Applicant: QUALCOMM Incorporated, San Diego, CA (US)

(72) Inventors: Gideon Shlomo KUTZ, Ramat Hasharon (IL); Assaf TOUBOUL, Netanya (IL); Tal OVED, Modiin (IL); Amit BAR-OR TILLINGER, Tel-Aviv (IL)

(21) Appl. No.: 17/932,580

(22) Filed: Sep. 15, 2022

(51) Int. Cl. H04W 52/02

(52) U.S. Cl. CPC H04W 52/0235

(57) ABSTRACT

Aspects described herein relate to receiving, in a component carrier (CC) configured for a first radio access technology (RAT), a wake-up signal indicating whether to activate communications for each of multiple RATs including a second RAT, and activating, based on the wake-up signal, communications in the first RAT or the second RAT. Other aspects relate to generating and/or transmitting the wake-up signal related to multiple RATs.

### FIELD OF THE DISCLOSURE

Aspects of the present disclosure relate generally to wireless communication systems, and more particularly, to techniques for performing layer 1/layer 2 mobility.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In some wireless communications technologies, such as long term evolution (LTE), 5G NR, etc., discontinuous receive (DRX) cycles are provided for improving power efficiency at user equipment (UE). DRX can introduce a tradeoff between power efficiency (using longer DRX cycles) and latency (using shorter DRX cycles). To improve power efficiency, a wake-up signal is defined in 5G NR to inform the UE if there is any relevant information in the next DRX ON cycle. If not, the UE can remain off during the next DRX ON duration to improve power efficiency where shorter DRX cycles are used.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a processor, memory coupled with the processor, and instructions stored in the memory. The instructions are operable, when executed by the processor, to cause the apparatus to receive, in a component carrier (CC) configured for a first radio access technology (RAT), a wake-up signal indicating whether to activate communications for each of multiple RATs including a second RAT, and activate, based on the wake-up signal, communications in the first RAT or the second RAT.

According to another aspect, an apparatus for wireless communication is provided that includes a processor, memory coupled with the processor, and instructions stored in the memory. The instructions are operable, when executed by the processor, to cause the apparatus to transmit, in a CC configured for a first RAT, a wake-up signal indicating whether to activate communications for each of multiple RATs including a second RAT, and transmit or receive, for a UE and based on transmitting the wake-up signal, communications in the first RAT or the second RAT.

In another aspect, a method for wireless communications at a UE is provided that includes receiving, in a CC configured for a first RAT, a wake-up signal indicating whether to activate communications for each of multiple RATs including a second RAT, and activating, based on the wake-up signal, communications in the first RAT or the second RAT.

In another aspect, a method for wireless communications at a network node is provided that includes transmitting, in a CC configured for a first RAT, a wake-up signal indicating whether to activate communications for each of multiple RATs including a second RAT, and transmitting or receiving, for a user equipment (UE) and based on transmitting the wake-up signal, communications in the first RAT or the second RAT.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for receiving a wake-up signal indicating information for multiple radio access technologies (RATs), component carriers (CCs), cells, etc., in accordance with aspects described herein;

FIG. 6 is a flow chart illustrating an example of a method for transmitting a wake-up signal indicting information for multiple RATs, CCs, cells, etc., in accordance with aspects described herein; and

FIG. 7 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to communicating wake-up signals between devices in a wireless network (e.g., between a user equipment (UE) and a base station or other UE) to indicate presence of information. A device receiving a wake-up signal can periodically monitor for the wake-up signal in a low power state, and can increase power to radio frequency (RF) components in a subsequent time period to receive communications based on the wake-up signal, or based on information provided by the wake-up signal. In some wireless technologies, such as fifth generation (5G) new radio (NR), wake-up signals are provided in a downlink control information (DCI) format to inform a UE if there is any relevant information in a discontinuous receive (DRX) ON duration of a next DRX cycle. If the UE receives the wake-up signal (or the wake-up signal indicates that information is available), in this example, the UE can power on RF components in the DRX ON duration of the next DRX cycle. If the UE does not receive the wake-up signal (or receives the wake-up signal indicating that information is not available), in this example, the UE can maintain low power state (or further reduce power) until a time period for possibly receiving a next wake-up signal. In this regard, power efficiency can be improved for DRX cycles.

In some examples, a device (e.g., UE) can be configured to concurrently support multiple radio access technologies (RATs), such as long term evolution (LTE), 5G NR sub-6 gigahertz, 5G NR millimeter wave (mmW), etc., and/or one or more associated component carriers (CCs). In some examples, the receiving device may use common hardware for these RATs, such as common digital signal processors (DSPs), central processing units (CPUs), hardware accelerators, RF components or chains of components, etc. In this regard, for example, the device or associated common hardware may have to be powered up from sleep mode for monitoring each given RAT, CC, etc. In addition, for example, each of these RATs might have different and possibly unsynchronized DRX cycles, and receiving functionality for the wake up signal may be specific to 5G NR RATs. As such, energy savings that can be achieved from DRX and wake-up signals may be significantly limited for a device that supports multiple RATs and/or associated CCs. For example, the amount of power saving for a device from sleep mode and/or wake-up signal in 5G may be very limited if the LTE modem in the device needs to be operated during the NR sleep cycle.

Accordingly, aspects described herein relate to communicating a multi-purpose wake-up signal, which can include, in a single signal, wake-up information for multiple RATs, associated CCs, associated cells (e.g., primary cells (PCells) or secondary cells (SCells), etc. For example, the wake-up signal can include multiple bits, where each bit can indicate whether the device is to wake-up (e.g., power on certain hardware, such as DSP, CPU, hardware accelerator, RF components, etc.) for a configured RAT, CC, cell, etc. In another example, certain properties of the wake-up signal, such as a waveform, can be used to indicate for which of multiple RATs, CCs, cells, etc. the device is to wake-up. In yet another example, the wake-up signal, or detection thereof, can point to or otherwise indicate another signal (e.g., a DCI wake-up signal) where a subset of the multiple configured RATs, CCs, cells, etc., for which the device is to wake-up, can be identified. In any case, a single wake-up signal can be used to inform a device to wake-up for multiple configured RATs, CCs, cells, etc. Using a single signal, in this regard, to wake-up the device in multiple configured RATs, CCs, cells, etc., for example, can improve power efficiency in the device, as described, which can conserve battery power and provide an improved user experience.

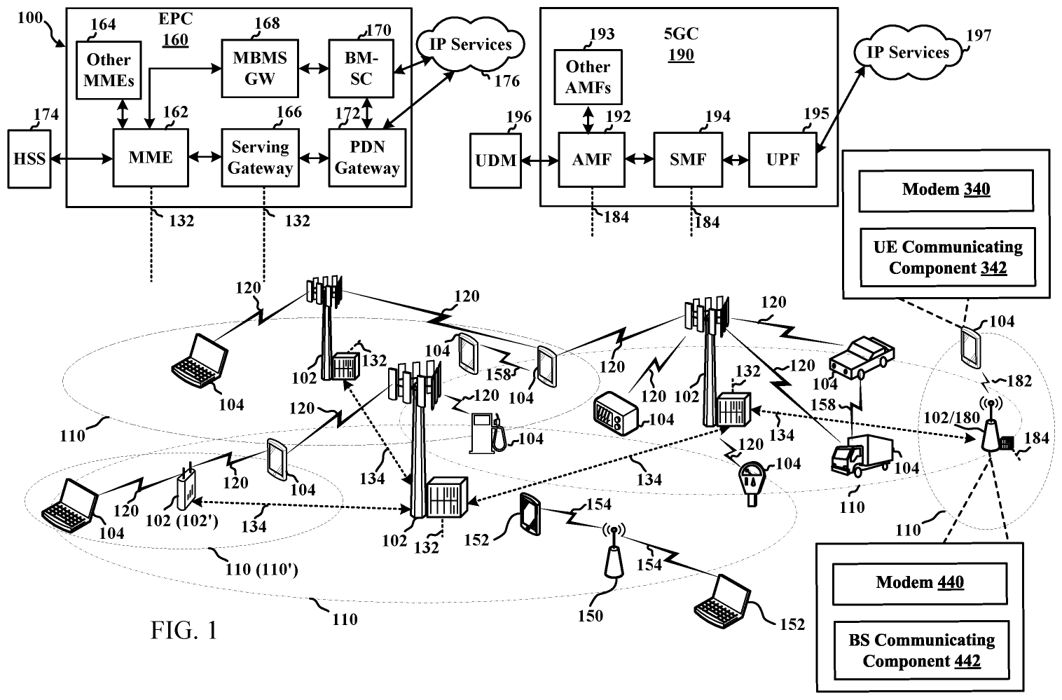

The described features will be presented in more detail below with reference to FIGS. 1-7.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for receiving a wake-up signal indicating information for multiple RATs, CCs, and/or cells, in accordance with aspects described herein. In addition, some nodes may have a modem 440 and BS communicating component 442 for transmitting a wake-up signal indicating information for multiple RATs, CCs, and/or cells, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an 51 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE communicating component 342 can receive a wake-up signal indicating information for multiple RATs, CCs, cells, etc., and can accordingly activate communications for one or more RATs, CCs, cells, etc. configured at the UE 104 based on the wake-up signal. For example, UE communicating component 342 can activate communications in a DRX ON duration or other subsequent period of time for the RATs, CCs, cells, etc. indicated in the wake-up signal, which may not include all RATs, CCs, cells, etc. configured at the UE 104. In an example, BS communicating component 442 can generate and transmit the wake-up signal for the UE 104 to indicate, for which of multiple RATs, CCs, cells, etc. configured at the UE 104, the UE 104 is to activate communications.

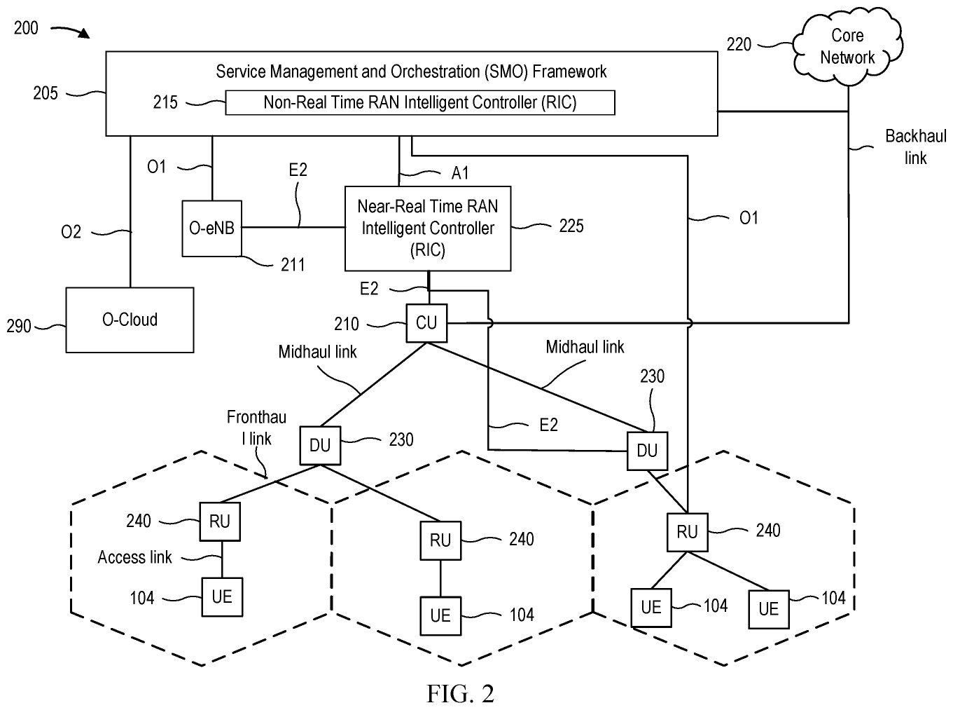

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

In an example, BS communicating component 442, as described herein, can be at least partially implemented within a CU 210 and/or one or more DUs 230 to generate and/or transmit the wake-up signal. In another example, BS communicating component 442, as described herein, can be at least partially implemented within one or more RUs 240 to generate and/or transmit the wake-up signal.

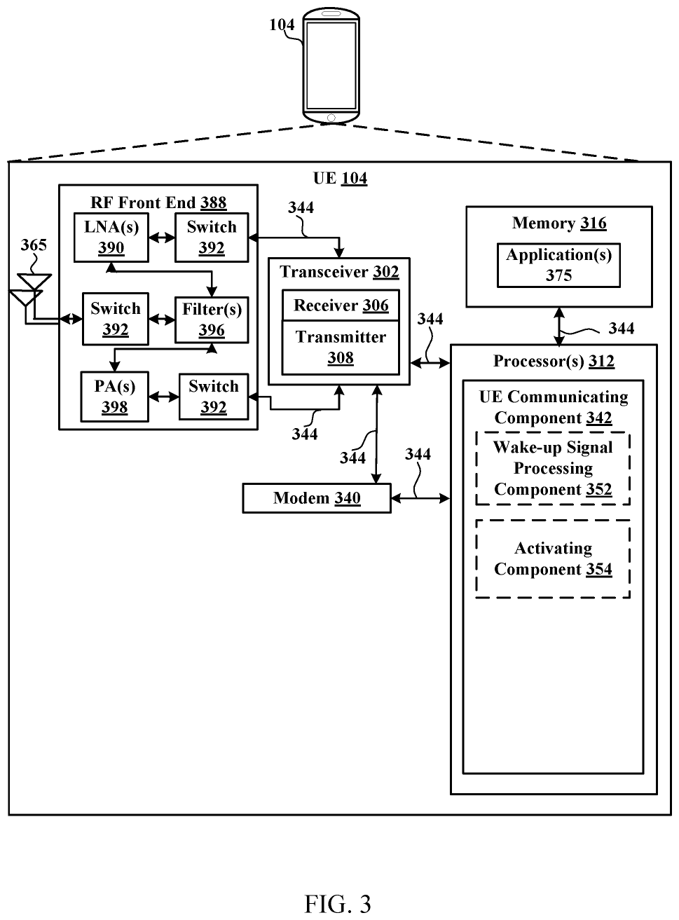

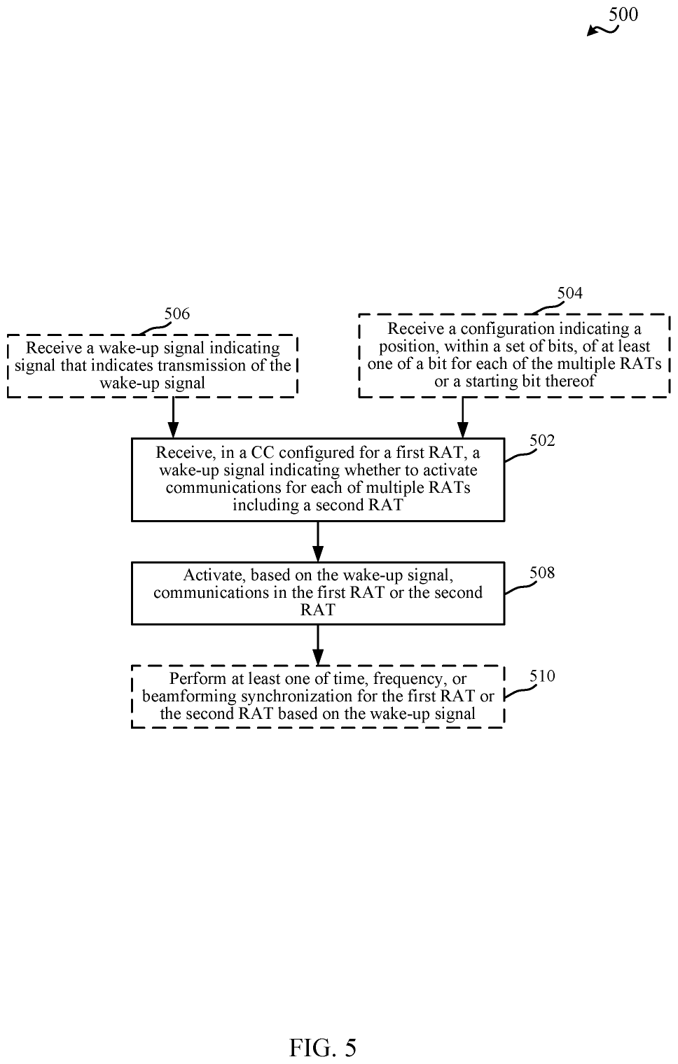

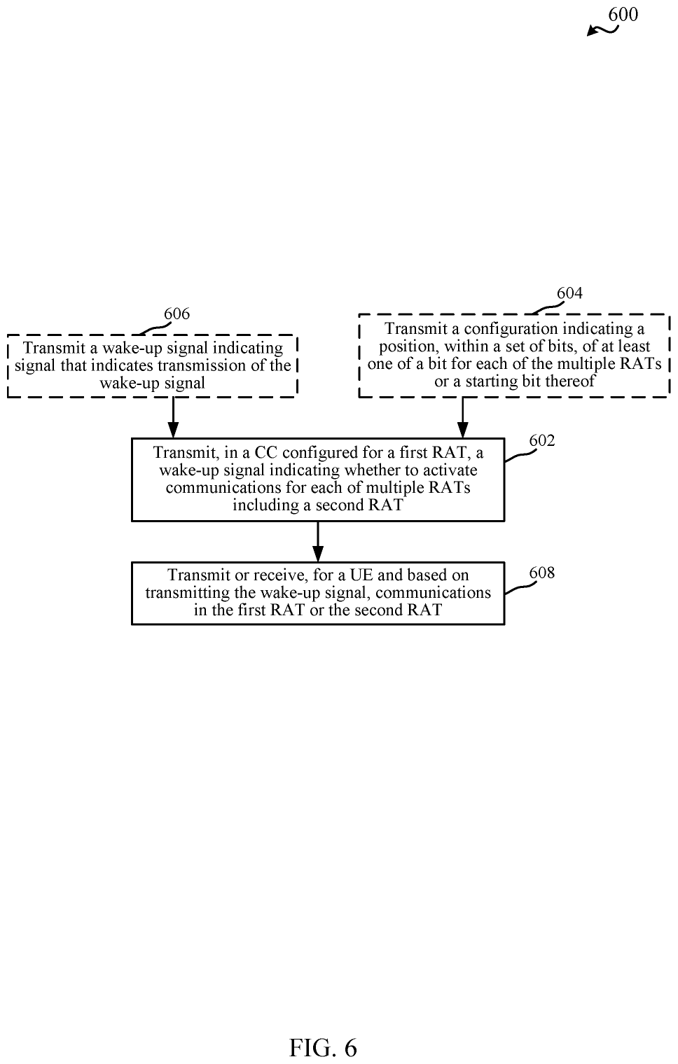

Turning now to FIGS. 3-7, aspects are depicted with reference to one or more components and one or more methods that may perform the actions or operations described herein, where aspects in dashed line may be optional. Although the operations described below in FIGS. 5 and 6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for receiving a wake-up signal indicating information for multiple RATs, CCs, and/or cells, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a wake-up signal processing component 352 for receiving and/or processing a wake-up signal that includes information related to multiple RATs, CCs, cells, etc., and/or an activating component 354 for activating communications with one or more of the multiple RATs, CCs, cells, etc. based on the wake-up signal, which can include activating certain hardware to communicate in the one or more of the multiple RATs, CCs, cells, etc., such as one or more components of the RF front end 388, one or more processors 312, etc., in accordance with aspects described herein.

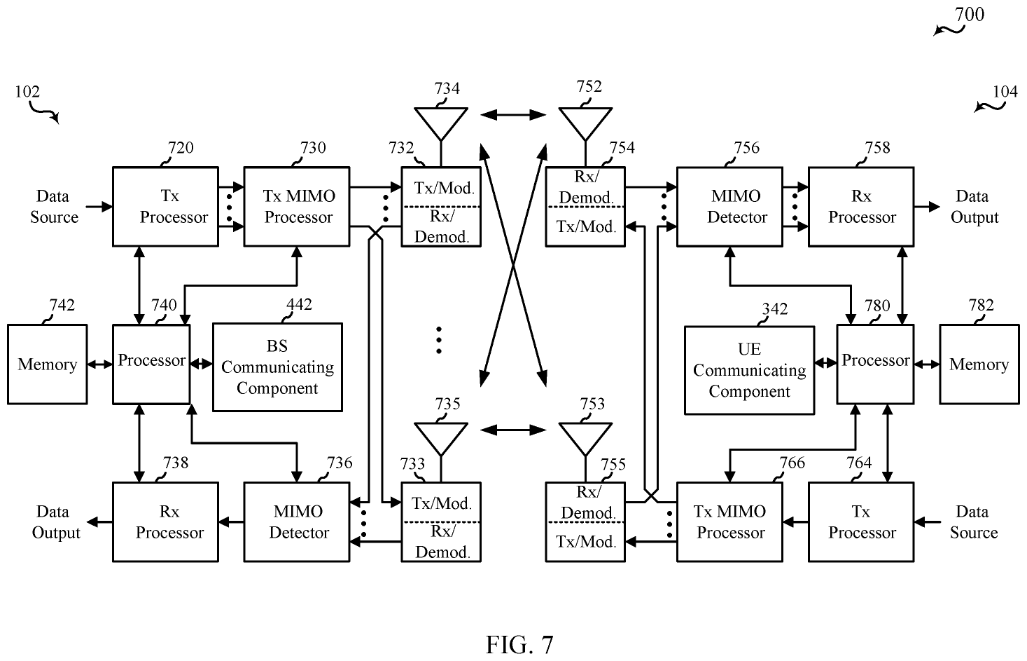

In an aspect, the processor(s) 312 may correspond to one or more of the processors described in connection with the UE in FIG. 7. Similarly, the memory 316 may correspond to the memory described in connection with the UE in FIG. 7.

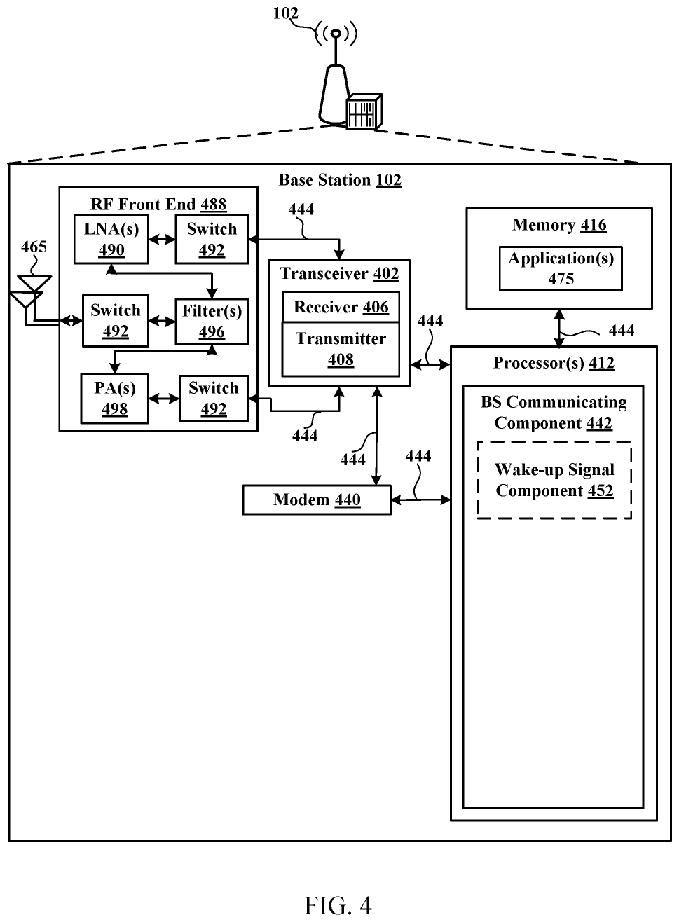

Referring to FIG. 4, one example of an implementation of base station 102 (e.g., a base station 102 and/or gNB 180, as described above) may include a variety of components, some of which have already been described above, but including components such as one or more processors 412 and memory 416 and transceiver 402 in communication via one or more buses 444, which may operate in conjunction with modem 440 and BS communicating component 442 for transmitting a wake-up signal indicating information for multiple RATs, CCs, and/or cells, in accordance with aspects described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a wake-up signal component 452 for generating and/or transmitting a wake-up signal that includes information related to multiple RATs, CCs, cells, etc., in accordance with aspects described herein.

In an aspect, the processor(s) 412 may correspond to one or more of the processors described in connection with the base station in FIG. 7. Similarly, the memory 416 may correspond to the memory described in connection with the base station in FIG. 7.

FIG. 5 illustrates a flow chart of an example of a method 500 for receiving a wake-up signal indicating information for multiple RATs, CCs, cells, etc., in accordance with aspects described herein. FIG. 6 illustrates a flow chart of an example of a method 600 for transmitting a wake-up signal indicting information for multiple RATs, CCs, cells, etc., in accordance with aspects described herein. In an example, a UE 104 can perform the functions described in method 500 using one or more of the components described in FIGS. 1 and 3. In an example, a base station 102 (e.g., a gNB, a monolithic base station, a portion of a disaggregated base station, etc.) can perform the functions described in method 600 using one or more of the components described in FIGS. 1 and 4. Methods 500 and 600 are described in conjunction with one another for ease of explanation; however, the methods 500 and 600 are not required to be performed together and indeed can be performed independently using separate devices.

In an example, a UE 104 can be configured (e.g., by a base station 102 or other network node) to communicate using multiple RATs, CCs in multiple RATs, cells in multiple RATs (e.g., PCells and/or SCells). Each RAT, CC, or cell can have an associated mechanism for activating communications, such to allow the UE 104 to sleep or power down (or decrease power to) certain hardware components during periods of time when communication is not expected to occur. This may include, for example, DRX cycles, and each RAT, CC, or cell can have its own DRX cycle, which may have different parameters (e.g., different durations or periodicity parameters), may be synchronized to different clocks correspond to different RATs or associated cells, etc. As such, wake-up information for one RAT, CC, or cell may not be relevant to another RAT, CC, or cell, and aspects described herein accordingly provide a wake-up signal that can communicate information for each of multiple RATs, CCs, cells, etc.

In method 600, at Block 602, a wake-up signal can be transmitted, in a CC configured for a first RAT, indicating whether to activate communications for each of multiple RATs including a second RAT. In an aspect, wake-up signal component 452, e.g., in conjunction with processor(s) 412, memory 416, transceiver 402, BS communicating component 442, etc., can transmit (e.g., to a UE 104), in the CC configured for the first RAT, the wake-up signal indicating whether to activate communications for each of multiple RATs including the second RAT. For example, the network node (e.g., base station 102) can configure communications with the UE 104 in the first RAT and using the CC, which may include the UE 104 performing a random access procedure or other connection establishment procedure with the network node to receive resource scheduling for wireless communications using the first RAT over the CC. In an example, the first RAT can include 5G NR or another wireless communication technology over which wake-up signals can be transmitted. In addition, for example, the wake-up signal can include information for multiple RATs, CCs, cells, etc. indicating whether to activate communications for each of the multiple RATs, CCs, cells, etc. In one example, the indication can relate to whether the UE 104 is to wake-up (e.g., activate or increase power to one or more hardware components) in a next DRX ON duration or other time instance or time period defined for the associated RAT.

In method 500, at Block 502, a wake-up signal can be received, in a CC configured for a first RAT, indicating whether to activate communications for each of multiple RATs including a second RAT. In an aspect, wake-up signal processing component 352, e.g., in conjunction with processor(s) 312, memory 316, transceiver 302, UE communicating component 342, etc., can receive (e.g., from a network node), in the CC configured for the first RAT, the wake-up signal indicating whether to activate communications for each of multiple RATs including the second RAT. As described, for example, the wake-up signal can include information for multiple RATs, CCs, cells, etc. indicating whether to activate communications for each of the multiple RATs, CCs, cells, etc.

For example, the wake-up signal can include a downlink control information (DCI) signal defined in the first RAT that is extended to indicate information for more than one RAT (e.g., for each of the multiple RATs). For example, the wake-up signal can include a DCI format 2_6 defined in 5G NR for notifying of power saving information outside of a DRX ON duration time for one or more UEs. For example, DCI format 2_6 can include a number, N, of blocks (or sets of bits) corresponding to each of N UEs and can have a cyclic redundancy check (CRC) scrambled by a power saving radio network temporary identifier (PS-RNTI). DCI format 2_6 can also include, for each configured UE, a 1-bit wake-up indicating and a SCell dormancy indication, which can be a bitmap per SCell group (SCG) configured for the UE, where each bit in the bitmap corresponds to one of the SCGs/RATs configured for the UE by higher layer parameters (e.g., radio resource control (RRC) parameters).

In one example, DCI format 2_6 can be extended such that the bitmap can also include any other cells in any other RATs that the UE supports or with which the UE is configured, such as LTE PCells or SCells, associated CCs, etc. In this example, wake-up signal component 452 can generate the wake-up signal as DCI format 2_6, where the bitmap can be used to indicate wake-up information (e.g., a bit indicating whether to wake-up) for each of multiple RATs, CCs, cells, etc., and can transmit the DCI format 2_6 to one or more UEs. In an example, wake-up signal processing component 352 can receive the wake-up signal from the network node as DCI format 2_6, and can determine the wake-up information for each of multiple RATs, CCs, cells, etc. as indicated by the bitmap. As the DCI format 2_6 can be generated for multiple UEs, for example, a given UE can be notified of its starting position for information in the block transmitted in the DCI format 2_6 by higher layer parameters configured for the UE.

For example, in method 600, optionally at Block 604, a configuration indicating a position, within a set of bits, of at least one of a bit for each of the multiple RATs or a starting bit thereof can be transmitted. In an aspect, wake-up signal component 452, e.g., in conjunction with processor(s) 412, memory 416, transceiver 402, BS communicating component 442, etc., can transmit the configuration indicating the position, within the set of bits, of at least one of a bit for each of the multiple RATs or a starting bit thereof. For example, wake-up signal component 452 can transmit, to each UE for which wake-up information is indicated in the wake-up signal, the configuration indicating a starting position within a block of data in the wake-up signal for the data relevant to the given UE. For example, for DCI format 2_6 in 5G NR, wake-up signal component 452 can transmit, to a given UE, the starting position in a parameter ps-PositionDCI-2-6 in higher layer signal (e.g., in RRC signaling). Wake-up signal component 452 can generate the wake-up signal having the wake-up data for the UE at the starting position within the block of data.

For example, in method 500, optionally at Block 504, a configuration indicating a position, within a set of bits, of at least one of a bit for each of the multiple RATs or a starting bit thereof can be received. In an aspect, wake-up signal processing component 352, e.g., in conjunction with processor(s) 312, memory 316, transceiver 302, UE communicating component 342, etc., can receive the configuration indicating the position, within the set of bits, of at least one of a bit for each of the multiple RATs or a starting bit thereof. In this example, wake-up signal processing component 352 can receive the wake-up signal and obtain the data relevant to the UE 104 based on the configured starting bit. For example, wake-up signal processing component 352 can obtain the wake-up indication, which may be for the first RAT, and the bitmap, which may include wake-up indications for other RATs, CCs, cells, etc.

In another example, a wake-up signal indicating signal can be used to notify of the wake-up signal (e.g., to notify of the DCI format 2_6 or other wake-up signal). For example, in method 600, optionally at Block 606, a wake-up signal indicating signal that indicates transmission of the wake-up signal can be transmitted. In an aspect, wake-up signal component 452, e.g., in conjunction with processor(s) 412, memory 416, transceiver 402, BS communicating component 442, etc., can transmit the wake-up signal indicating signal that indicates transmission of the wake-up signal. For example, the wake-up signal indicating signal can be a less complex signal such that UEs can monitor for the wake-up signal indicating signal and refrain from decoding a more complex signal, such as the DCI format 2_6, until or unless the wake-up signal indicating signal is received. In an example, the wake-up signal indicating signal may point the UE to the DCI based wake-up signal where the activated RATs, CCs, cells, etc. can be identified. For example, wake-up signal component 452 can transmit the wake-up signal indicating signal over resources defined in the wireless communication technology of the first RAT (e.g., 5G NR) or in resources otherwise configured for the UE 104, and can transmit the associated wake-up signal at Block 602.

For example, in method 500, optionally at Block 506, a wake-up signal indicating signal that indicates transmission of the wake-up signal can be received. In an aspect, wake-up signal processing component 352, e.g., in conjunction with processor(s) 312, memory 316, transceiver 302, UE communicating component 342, etc., can receive the wake-up signal indicating signal that indicates transmission of the wake-up signal. In an example, wake-up signal processing component 352 can receive the wake-up signal indicating signal in known or configured resources, as described, and can receive the wake-up signal at Block 502 based on the wake-up signal indicating signal. For example, the wake-up signal indicating signal can indicate that the wake-up signal is transmitted, resources over which the wake-up signal is transmitted, etc. Thus, for example, wake-up signal processing component 352 can determine to receive the wake-up signal or resources over which to receive the wake-up signal based on presence of the wake-up signal indicating signal or one or more parameters of the wake-up signal indicating signal, etc. In one example, wake-up signal component 452 can transmit, and/or wake-up signal processing component 352 can receive, the wake-up signal over a CC of the first RAT (e.g., a 5G PCell CC).

In another example, the wake-up signal can include a newly defined wake-up signal in the first RAT (e.g., in 5G NR). For instance, wake-up signal component 452 can transmit the wake-up signal, and/or wake-up signal processing component 352 can receive the wake-up signal, using a 5G PCell CC. In an example, a waveform of the wake-up signal can indicate the wake-up information for the multiple RATs. For example, the activated RATs can be embedded by having a single waveform per RAT per UE. In this example, wake-up signal component 452 can generate the waveform of the wake-up signal for a given RAT for a given UE to indicate that the UE is to activate communications or otherwise wake-up for receiving information in the given RAT (or CC, cell, etc.). Wake-up signal component 452 can transmit the wake-up signal. Wake-up signal processing component 352 can monitor wake-up signal resources in the first RAT and can receive the wake-up signal in the first RAT. In this example, wake-up signal processing component 352 can determine to which RAT, CC, cell, etc. the wake-up signal applies based on the waveform of the wake-up signal. In one example, an indication of waveform to associated RAT, CC, cell, etc. and/or UE can be configured for the UE by the network node (e.g., in higher layer signaling). In another example, the waveform may be computed by the network node and/or UE 104 based on one or more parameters of the RAT, CC, cell, etc., and/or UE, such as a UE identifier, a configuration index related to the RAT, CC, cell, etc., and/or the like.

In method 500, at Block 508, communications in the first RAT or the second RAT can be activated based on the wake-up signal. In an aspect, activating component 354, e.g., in conjunction with processor(s) 312, memory 316, transceiver 302, UE communicating component 342, etc., can activate, based on the wake-up signal, communications in the first RAT or the second RAT. For example, wake-up signal processing component 352 can decode the wake-up signal to determine which RAT(s), CC(s), cell(s), etc. to activate. This can be based on the bitmap indicated in DCI format 2_6, the waveform of one or more wake-up signals, etc., as described above. Based on determining the RAT(s), CC(s), cell(s), etc. indicated in the wake-up signal for activation, activating component 354 can activate communications in the appropriate RAT, for the associated CC or cell, etc. As described, for example, activating component 354 can wake-up or increase power to hardware components of the UE 104 for communicating in the RAT, CC, cell, etc., in a certain period of time, such as at a next DRX ON duration. This can allow the UE 104 to wake-up for only certain RATs, CCs, cells, etc., for which the multi-purpose wake-up signal indicates to wake-up, which can conserve power where the UE 104 need not wake-up for certain RATs, CCs, cells, etc.

In method 600, at Block 608, communications can be transmitted or received in the first RAT or the second RAT, for a UE and based on transmitting the wake-up signal. In an aspect, BS communicating component 442, e.g., in conjunction with processor(s) 412, memory 416, transceiver 402, etc., can transmit or receive, for the UE (e.g., UE 104) and based on transmitting the wake-up signal, communications in the first RAT or the second RAT. For example, based on indicating to activate the communications in the wake-up signal, the UE 104 can wake-up hardware to receive or transmit signals for the associated RAT, and BS communicating component 442 can similarly transmit or receive communications in the first RAT or second RAT over scheduled resources and based on wake-up information included in the wake-up signal.

In an example, though the wake-up signal is received in the first RAT, it can be used for performing synchronization in or for other RATs. In method 500, optionally at Block 510, at least one of time, frequency, or beamforming synchronization can be performed for the first RAT or the second RAT based on the wake-up signal. In an aspect, UE communicating component 342, e.g., in conjunction with processor(s) 312, memory 316, transceiver 302, etc., can perform at least one of time, frequency, or beamforming synchronization for the first RAT or the second RATs (and/or other RATs, CCs, cells, etc. configured at the UE 104) based on the wake-up signal. For example, UE communicating component 342 can perform synchronization for the first RAT using techniques defined in the RAT (e.g., in 5G NR), and/or may perform some collaborative processing of timing, frequency and beamforming synchronization between RATs based on the wake-up signal to synchronize other RATs with the network node and/or other network nodes.

FIG. 7 is a block diagram of a MIMO communication system 700 including a base station 102 and a UE 104. The MIMO communication system 700 may illustrate aspects of the wireless communication access network 100 described with reference to FIG. 1. The base station 102 may be an example of aspects of the base station 102 described with reference to FIG. 1. The base station 102 may be equipped with antennas 734 and 735, and the UE 104 may be equipped with antennas 752 and 753. In the MIMO communication system 700, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 720 may receive data from a data source. The transmit processor 720 may process the data. The transmit processor 720 may also generate control symbols or reference symbols. A transmit MIMO processor 730 may perform spatial processing (e.g., precoding) on data symbols, control symbols, or reference symbols, if applicable, and may provide output symbol streams to the transmit modulator/demodulators 732 and 733. Each modulator/demodulator 732 through 733 may process a respective output symbol stream (e.g., for OFDM, etc.) to obtain an output sample stream. Each modulator/demodulator 732 through 733 may further process (e.g., convert to analog, amplify, filter, and upconvert) the output sample stream to obtain a DL signal. In one example, DL signals from modulator/demodulators 732 and 733 may be transmitted via the antennas 734 and 735, respectively.

The UE 104 may be an example of aspects of the UEs 104 described with reference to FIGS. 1 and 3. At the UE 104, the UE antennas 752 and 753 may receive the DL signals from the base station 102 and may provide the received signals to the modulator/demodulators 754 and 755, respectively. Each modulator/demodulator 754 through 755 may condition (e.g., filter, amplify, downconvert, and digitize) a respective received signal to obtain input samples. Each modulator/demodulator 754 through 755 may further process the input samples (e.g., for OFDM, etc.) to obtain received symbols. A MIMO detector 756 may obtain received symbols from the modulator/demodulators 754 and 755, perform MIMO detection on the received symbols, if applicable, and provide detected symbols. A receive (Rx) processor 758 may process (e.g., demodulate, deinterleave, and decode) the detected symbols, providing decoded data for the UE 104 to a data output, and provide decoded control information to a processor 780, or memory 782.

The processor 780 may in some cases execute stored instructions to instantiate a UE communicating component 342 (see e.g., FIGS. 1 and 3).

On the uplink (UL), at the UE 104, a transmit processor 764 may receive and process data from a data source. The transmit processor 764 may also generate reference symbols for a reference signal. The symbols from the transmit processor 764 may be precoded by a transmit MIMO processor 766 if applicable, further processed by the modulator/demodulators 754 and 755 (e.g., for single carrier-FDMA, etc.), and be transmitted to the base station 102 in accordance with the communication parameters received from the base station 102. At the base station 102, the UL signals from the UE 104 may be received by the antennas 734 and 735, processed by the modulator/demodulators 732 and 733, detected by a MIMO detector 736 if applicable, and further processed by a receive processor 738. The receive processor 738 may provide decoded data to a data output and to the processor 740 or memory 742.

The processor 740 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 700. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 700.

The following aspects are illustrative only and aspects thereof may be combined with aspects of other embodiments or teaching described herein, without limitation.

Aspect 1 is a method for wireless communications at a UE including receiving, in a CC configured for a first RAT, a wake-up signal indicating whether to activate communications for each of multiple RATs including a second RAT, and activating, based on the wake-up signal, communications in the first RAT or the second RAT.

In Aspect 2, the method of Aspect 1 includes where the wake-up signal includes a bit for each of the multiple RATs including the second RAT.

In Aspect 3, the method of any of Aspects 1 or 2 includes where the wake-up signal includes a bit for each of multiple CCs related to the first RAT or the second RAT, and where activating the communications in the first RAT or the second RAT includes activating communications with one of the multiple CCs related to the first RAT or the second RAT as indicated by the bits of the wake-up signal.

In Aspect 4, the method of any of Aspects 1 to 3 includes where the wake-up signal includes a bit for each of multiple SCells related to the first RAT or the second RAT, and where activating the communications in the first RAT or the second RAT includes activating communications with one of the multiple SCells related to the first RAT or the second RAT as indicated by the bits of the wake-up signal.

In Aspect 5, the method of any of Aspects 1 to 4 includes where the wake-up signal includes sets of bits for each of multiple UEs, and receiving a configuration indicating a position, within the sets of bits, of at least one of the bit for each of the multiple RATs corresponding to the UE, or a starting bit of the bit for each of the multiple RATs corresponding to the UE.

In Aspect 6, the method of any of Aspects 1 to 5 includes where the wake-up signal includes a DCI format 2_6.

In Aspect 7, the method of any of Aspects 1 to 6 includes where activating communications for the first RAT or the second RAT is based on a waveform of the wake-up signal indicating the first RAT or the second RAT.

In Aspect 8, the method of Aspect 7 includes where the CC is a 5G primary cell CC.

In Aspect 9, the method of any of Aspects 1 to 8 includes where activating communications for the first RAT or the second RAT is based on a waveform of the wake-up signal indicating a SCell group corresponding to the first RAT or the second RAT.

In Aspect 10, the method of Aspect 9 includes where the CC is a 5G primary cell CC.

In Aspect 11, the method of any of Aspects 1 to 10 includes receiving a wake-up signal indication signal that indicates resources for receiving the wake-up signal, where receiving the wake-up signal is based on receiving the wake-up signal indication signal.

In Aspect 12, the method of Aspect 11 includes where receiving the wake-up signal indication signal is over a 5G primary cell CC.

In Aspect 13, the method of any of Aspects 1 to 12 includes processing at least one of time, frequency, or beamforming synchronization for the first RAT and the second RAT based on the wake-up signal.

Aspect 14 is a method for wireless communications at a network node includes transmitting, in a CC configured for a first RAT, a wake-up signal indicating whether to activate communications for each of multiple RATs including a second RAT, and transmitting or receiving, for a UE and based on transmitting the wake-up signal, communications in the first RAT or the second RAT.

In Aspect 15, the method of Aspect 14 includes where the wake-up signal includes a bit for each of the multiple RATs including the second RAT.

In Aspect 16, the method of any of Aspects 14 or 15 includes where the wake-up signal includes a bit for each of multiple CCs related to the first RAT or the second RAT

In Aspect 17, the method of any of Aspects 14 to 16 includes where the wake-up signal includes a bit for each of multiple SCells related to the first RAT or the second RAT.

In Aspect 18, the method of any of Aspects 14 to 17 includes where the wake-up signal includes sets of bits for each of multiple UEs, and transmitting, for the UE, a configuration indicating a position, within the sets of bits, of at least one of the bit for each of the multiple RATs corresponding to the UE, or a starting bit of the bit for each of the multiple RATs corresponding to the UE.

In Aspect 19, the method of any of Aspects 14 to 18 includes where the wake-up signal includes a DCI format 2_6.

In Aspect 20, the method of any of Aspects 14 to 19 includes where a waveform of the wake-up signal indicates the first RAT or the second RAT.

In Aspect 21, the method of Aspect 20 includes where the CC is a 5G primary cell CC.

In Aspect 22, the method of any of Aspects 14 to 21 includes where a waveform of the wake-up signal indicates a SCell group corresponding to the first RAT or the second RAT.

In Aspect 23, the method of Aspect 22 includes where the CC is a fifth generation 5G primary cell CC.

In Aspect 24, the method of any of Aspects 14 to 23 includes transmitting a wake-up signal indication signal that indicates resources for receiving the wake-up signal, where transmitting the wake-up signal is based on transmitting the wake-up signal indication signal.

In Aspect 25, the method of Aspect 24 includes where transmitting the wake-up signal indication signal is over a 5G primary cell CC.

Aspect 33 is an apparatus for wireless communication including a processor, memory coupled with the processor, and instructions stored in the memory and operable, when executed by the processor, to cause the apparatus to perform any of the methods of Aspects 1 to 32.

Aspect 34 is an apparatus for wireless communication including means for performing any of the methods of Aspects 1 to 32.

Aspect 35 is a computer-readable medium including code executable by one or more processors for wireless communications, the code including code for performing any of the methods of Aspects 1 to 32.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a processor;
memory coupled with the processor; and
instructions stored in the memory and operable, when executed by the processor, to cause the apparatus to:
receive, in a component carrier (CC) configured for a first radio access technology (RAT), a wake-up signal indicating whether to activate communications for each of multiple RATs including a second RAT; and
activate, based on the wake-up signal, communications in the first RAT or the second RAT.

2. The apparatus of claim 1, wherein the wake-up signal includes a bit for each of the multiple RATs including the second RAT.

3. The apparatus of claim 1, wherein the wake-up signal includes a bit for each of multiple CCs related to the first RAT or the second RAT, and wherein the instructions, when executed by the processor, cause the apparatus to activate the communications in the first RAT or the second RAT at least in part by activating communications with one of the multiple CCs related to the first RAT or the second RAT as indicated by the bits of the wake-up signal.

4. The apparatus of claim 1, wherein the wake-up signal includes a bit for each of multiple secondary cells (SCells) related to the first RAT or the second RAT, and wherein the instructions, when executed by the processor, cause the apparatus to activate the communications in the first RAT or the second RAT at least in part by activating communications with one of the multiple SCells related to the first RAT or the second RAT as indicated by the bits of the wake-up signal.

5. The apparatus of claim 1, wherein the wake-up signal includes sets of bits for each of multiple UEs, and wherein the instructions, when executed by the processor, cause the apparatus to receive a configuration indicating a position, within the sets of bits, of at least one of the bit for each of the multiple RATs corresponding to the apparatus, or a starting bit of the bit for each of the multiple RATs corresponding to the apparatus.

6. The apparatus of claim 1, wherein the wake-up signal includes a downlink control information (DCI) format 2_6.

7. The apparatus of claim 1, wherein the instructions, when executed by the processor, cause the apparatus to activate communications for the first RAT or the second RAT based on a waveform of the wake-up signal indicating the first RAT or the second RAT.

8. The apparatus of claim 7, wherein the CC is a fifth generation (5G) primary cell CC.

9. The apparatus of claim 1, wherein the instructions, when executed by the processor, cause the apparatus to activate communications for the first RAT or the second RAT based on a waveform of the wake-up signal indicating a secondary cell (SCell) group corresponding to the first RAT or the second RAT.

10. The apparatus of claim 9, wherein the CC is a fifth generation (5G) primary cell CC.

11. The apparatus of claim 1, wherein the instructions, when executed by the processor, cause the apparatus to receive a wake-up signal indication signal that indicates resources for receiving the wake-up signal, wherein the instructions, when executed by the processor, cause the apparatus to receive the wake-up signal based on receiving the wake-up signal indication signal.

12. The apparatus of claim 11, wherein the instructions, when executed by the processor, cause the apparatus to receive the wake-up signal indication signal over a fifth generation (5G) primary cell CC.

13. The apparatus of claim 1, wherein the instructions, when executed by the processor, cause the apparatus to process at least one of time, frequency, or beamforming synchronization for the first RAT and the second RAT based on the wake-up signal.

14. An apparatus for wireless communication, comprising:
a processor;
memory coupled with the processor; and
instructions stored in the memory and operable, when executed by the processor, to cause the apparatus to:
transmit, in a component carrier (CC) configured for a first radio access technology (RAT), a wake-up signal indicating whether to activate communications for each of multiple RATs including a second RAT; and
transmit or receive, for a user equipment (UE) and based on transmitting the wake-up signal, communications in the first RAT or the second RAT.

15. The apparatus of claim 14, wherein the wake-up signal includes a bit for each of the multiple RATs including the second RAT.

16. The apparatus of claim 14, wherein the wake-up signal includes a bit for each of multiple CCs related to the first RAT or the second RAT.

17. The apparatus of claim 14, wherein the wake-up signal includes a bit for each of multiple secondary cells (SCells) related to the first RAT or the second RAT.

18. The apparatus of claim 14, wherein the wake-up signal includes sets of bits for each of multiple UEs, and wherein the instructions, when executed by the processor, cause the apparatus to transmit, for the UE, a configuration indicating a position, within the sets of bits, of at least one of the bit for each of the multiple RATs corresponding to the UE, or a starting bit of the bit for each of the multiple RATs corresponding to the UE.

19. The apparatus of claim 14, wherein the wake-up signal includes a downlink control information (DCI) format 2_6.

20. The apparatus of claim 14, wherein a waveform of the wake-up signal indicates the first RAT or the second RAT.

21. The apparatus of claim 20, wherein the CC is a fifth generation (5G) primary cell CC.

22. The apparatus of claim 14, wherein a waveform of the wake-up signal indicates a secondary cell (SCell) group corresponding to the first RAT or the second RAT.

23. The apparatus of claim 22, wherein the CC is a fifth generation (5G) primary cell CC.

24. The apparatus of claim 14, wherein the instructions, when executed by the processor, cause the apparatus to transmit a wake-up signal indication signal that indicates resources for receiving the wake-up signal, wherein the instructions, when executed by the processor, cause the apparatus to transmit the wake-up signal based on transmitting the wake-up signal indication signal.

25. The apparatus of claim 24, wherein the instructions, when executed by the processor, cause the apparatus to transmit the wake-up signal indication signal over a fifth generation (5G) primary cell CC.

26. A method for wireless communications at a user equipment (UE), comprising:
receiving, in a component carrier (CC) configured for a first radio access technology (RAT), a wake-up signal indicating whether to activate communications for each of multiple RATs including a second RAT; and
activating, based on the wake-up signal, communications in the first RAT or the second RAT.

27. The method of claim 26, wherein the wake-up signal includes a bit for each of the multiple RATs including the second RAT.

28. The method of claim 26, wherein the wake-up signal includes a bit for each of multiple CCs related to the first RAT or the second RAT, and wherein activating the communications in the first RAT or the second RAT includes activating communications with one of the multiple CCs related to the first RAT or the second RAT as indicated by the bits of the wake-up signal.

29. A method for wireless communications at a network node, comprising:
transmitting, in a component carrier (CC) configured for a first radio access technology (RAT), a wake-up signal indicating whether to activate communications for each of multiple RATs including a second RAT; and
transmitting or receiving, for a user equipment (UE) and based on transmitting the wake-up signal, communications in the first RAT or the second RAT.

30. The method of claim 29, wherein the wake-up signal includes a bit for each of the multiple RATs including the second RAT.
